(19) United States
(12) Patent Application Publication
(10) Pub. No.: US 2005/0052448 A1
(43) Pub. Date: Mar. 10, 2005

(54) Drive device and drive method of light emitting display panel

(75) Inventors: Akinori Hayafuji, Yonezawa-shi (JP); Katsuhiro Kanauchi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/893,264

(22) Filed: Jul. 19, 2004

(30) Foreign Application Priority Data
Jul. 29, 2003 (JP) 2003-202866

(51) Int. Cl. G09G 5/00

(52) U.S. Cl. 345/212; 345/204

(57) ABSTRACT

The present invention is to provide a drive device which can efficiently collect electrical charges accumulated in the parasitic capacitances of light emitting elements so as to reduce power consumption in a light emitting display panel. Control is performed in such a manner that respective EL elements which become lighting objects are allowed to sequentially begin to be lit in response to a length of time determined in accordance with gradation control during a constant current drive period and that extinguishing timing of the respective light emitting elements which have received lighting control corresponds to the end of the lighting drive period. Thus, lighting time of the EL elements during the constant current drive period is controlled in accordance with gradation, and multi-gradation expression can be realized for each pixel. When the above-described gradation control method is adopted, regardless of the aspect of gradation control, electrical charges accumulated in the parasitic capacitances of the respective EL elements can be efficiently collected via all drive lines immediately after the completion of the constant current drive period.

### BACKGROUND OF THE INVENTION

1. Field of the Invention

The present invention relates to a drive device of a light emitting display panel in which capacitive light emitting elements, for example organic EL (electroluminescent) elements, are employed, and particularly to a drive device and a drive method in which the power consumption in the light emitting display panel can be reduced by efficiently collecting electrical charges accumulated in the parasitic capacitances of the light emitting elements accompanied by driving and lighting for the light emitting elements.

2. Description of the Related Art

A display panel constructed by arranging light emitting elements in a matrix pattern has been developed widely, and as the light emitting element employed in such a display panel, an organic EL element in which an organic material is employed in a light emitting layer has attracted attention. This is because of backgrounds one of which is that by employing, in the light emitting layer of the element, an organic compound which enables an excellent light emitting characteristic to be expected, a high efficiency and a long life which make an EL element satisfactorily practicable have been advanced.

The organic EL element can be electrically replaced with a structure composed of a light emitting element having a diode characteristic and a parasitic capacitance element which is connected in parallel to this light emitting element, and it can be stated that the organic EL element is a capacitive light emitting element.

When a light emission drive voltage is applied to this organic EL element, at first, electrical charges corresponding to the electric capacity of this element flow into an electrode as a displacement current and are accumulated. It can be considered that when the voltage then exceeds a determined voltage (light emission threshold voltage=Vth) peculiar to the element in question, current begins to flow from the electrode (anode terminal side of the diode element) to an organic layer constituting the light emitting layer so that the element emits light at an intensity proportional to this current.

In general, a constant current drive is performed for the organic EL element due to the reason that the voltage vs. intensity characteristic is unstable with respect to temperature changes while the current vs. intensity characteristic is stable with respect to temperature changes, the reason that deterioration of the organic EL element is drastic in the case where this element receives an excess current so that the light emission lifetime thereof is shortened, and the like. As a display panel employing such organic EL elements, a passive drive type display panel in which the elements are arranged in a matrix pattern has already been put into practical use partly.

Meanwhile, in the passive drive type display panel employing the capacitive light emitting elements represented by the above-mentioned organic EL elements, in order to drive and light the light emitting elements, at first, it is necessary to charge electrical charges in the parasitic capacitances of the light emitting elements which become lighting objects, and when a non-lighting state is brought, an operation that the electrical charges accumulated in the parasitic capacitances are discharged is performed in the next operation mode.

Particularly, the passive drive type display panel has a problem that cross talk light emission occurs according to operational principles thereof, and in order to prevent such cross talk light emission, an operation to apply a reverse bias voltage to light emitting elements which are in a non-lighting state is performed, whereby electrical charges accumulated in the parasitic capacitance are discharged. Therefore, when the number of light emitting elements arranged in a display panel becomes large, in accordance with this increment, power loss due to discharge of electrical charges accumulated in the parasitic capacitances becomes large.

Japanese Patent Application Laid-Open No. 2003-5711 (paragraphs 0037 to 0044 and FIG. 2) discloses a structure of a drive circuit to reduce power consumption of a display panel by collecting electrical charges accumulated in the parasitic capacitances of the above-mentioned organic EL elements accompanied by the lighting operation of these EL elements and by supplying these collected charges to a power supply circuit again.

Meanwhile, in the above-described passive drive type display panel, current gradation control in which the value of current supplied to the EL elements is controlled in accordance with gradation to change the light emission intensity of the EL element has been known as one means for realizing multi-gradation expression. As another means, time gradation control in which the value of current supplied to the EL element is set at a constant value (constant current) and in which a lighting period in a constant current drive period for each scan is controlled in accordance with gradation has also been known.

The former current gradation control has a technical problem that the degree to give the light emission intensity of the EL element fluctuations is extremely large due to variations occurring in the manufacture of EL elements and of active elements and the like constituting a drive circuit and that gradation control is difficult due to existence of factors to control the drive current in an analogue manner. Unlike the former, the time gradation control is hardly influenced by intensity changes caused by variations occurring in the manufacture since the latter time gradation control is for controlling the time given the EL element in accordance with gradation. The time gradation control can be suitably adopted in gradation control for a display panel of this type since gradation can be controlled, in a sense, at digital time division.

FIGS. 1 to 4 are for explaining a basic structure and its function which realizes multi-gradation expression by the above-described time gradation and which still collects electrical charges (electrical power) accumulated in the parasitic capacitances of the organic EL elements accompanied by the lighting operation of the organic EL elements so as to improve the utilization efficiency of electrical power. First, FIG. 1 shows a operation state of a drive switch which is brought in a constant current drive period of each scan in order to realize the above-mentioned time gradation.

The embodiment shown in FIG. 1 is to realize gradation of n steps, and in order to express low gradation (e.g., gradation 1, gradation 2, and the like), a period in which the drive switch is turned on and which starts from the start of the constant current drive period is set to a short time period. In order to express high gradation, the period in which the drive switch is turned on and which starts from the start of the constant current drive period is set to a long period of time. That is, in order to express the highest gradation n, during the entire constant current drive period, the drive switch is turned on.

FIGS. 2 to 4 sequentially explain an embodiment of control in timings shown by t1 to t3 in FIG. 1, wherein FIG. 2 (that is, the drawing showing an operation of the time of t1 of FIG. 1) shows the state of the start time of the constant current drive period as a lighting drive period, FIG. 3 (that is, the drawing showing an operation of the time of t2 of FIG. 1) shows the state of immediately before a power collection operation, and further FIG. 4 (that is, the drawing showing an operation of the time of t3 of FIG. 1) shows the state of when the power collection operation is performed, respectively. In FIGS. 2 to 4, I1 to In denote constant current circuits, Sa1 to San drive switches, and C2 a power collection capacitor. Each parallel connection body denoted by symbols/marks of a diode and a capacitor represents a pixel of one dot constituted by an organic EL element provided as a light emitting element.

Further, in any of FIGS. 2 to 4, for convenience of space, respective three drive lines and scan lines are drawn in a column direction and a row direction, respectively. FIGS. 2 to 4 show a case where pixels corresponding to the left side anode line are expressed at “gradation 1”, pixels corresponding to the central anode line are expressed at “gradation 2”, and pixels corresponding to the right side anode line are expressed at “gradation n”, respectively, among the anode lines as the three drive lines arranged in the column direction. FIGS. 2 to 4 show a state in which the two cathode lines are brought to a non-scan state (non-selected lines), and the bottom one cathode line (third cathode line) is brought to a scan state (selected line) among the cathode lines as the three scan lines arranged in the row direction.

First, at the time of t1 shown in FIG. 1, that is, at the start time of the constant current drive operation as the lighting drive period, the drive switches Sa1 to San are controlled to be in an ON state, and the drive switches Sa1 to San are all connected to the constant current circuits I1 to In sides as shown in FIG. 2. The upper two cathode lines are made to the non-selected lines, and a reverse bias voltage VM is supplied to them. A voltage VL is supplied to the third cathode line, and the EL elements connected to this cathode line is brought to the scan (selected) state.

In this state, constant current from the respective constant current sources I1 to In is supplied to the respective anode terminals of the EL elements connected to the selected line, and an electrical potential denoted as VL is supplied to the cathode terminals thereof. As a result, the respective EL elements connected to the selected line are driven and lit as enclosed within circles. At this time, the forward voltage of the EL elements which are driven and lit is shown as VF. Meanwhile, the above-mentioned forward voltage VF is applied to the anode terminals of the EL elements connected to the non-selected lines, and the reverse bias voltage VM is supplied to the cathode terminals thereof.

Next, at the time of t2 shown in FIG. 1, that is, in the state of immediately before the power collection operation, only the drive switch San is controlled to be in the ON state, the drive switch San is connected to the constant current circuit In side, and the drive switches Sa1, Sa2 are connected to the potential VA as shown in FIG. 3. In short, as time elapses from t1 to t2, supply from the constant current sources to the anode lines which are controlled to be low gradation designated by gradation 1 and gradation 2 is sequentially stopped, and the electrical potential denoted as VA is supplied to these anode lines. Here, the above-mentioned respective electrical potentials have a relationship of VM>VF>VA>VL.

Therefore, at this time, only the EL element controlled to be gradation n on the selected line is driven to be lit as circled. At this time, a state in which the electrical potential VA is supplied to the anode terminals of the respective EL elements connected to the anode lines which receive non-lighting control (the anode lines controlled to be gradation 1 and gradation 2 in FIG. 3) is brought so that an extinguished state is brought. Thus, the respective lighting times of the respective EL elements connected to the selected line are controlled, and multi-gradation expression by time gradation is realized.

Then, at the time of t3 shown in FIG. 1, that is, in the power collection operation, the drive switches Sa1 to San are all connected to the power collection capacitor C2 side as shown in FIG. 4. Thus, the anode terminals of all EL elements are all connected to the power collection capacitor C2 via the respective anode lines. As a result, electrical charges (electrical power) accumulated in the parasitic capacitances of the respective EL elements are transferred to the power collection capacitor C2 so that the electrical charges are collected.

However, electrical charges which can be collected in the capacitor C2 are ones accumulated in the element connected to the anode line which is controlled at gradation n and which has been driven to be lit immediately before the power collection operation. In other words, in the case where an EL element that is an object to be controlled to be the brightest gradation n does not exist in scan thereof, collection of electrical power in this scan becomes impossible, and collection efficiency of electrical power is conspicuously low.

### SUMMARY OF THE INVENTION

The present invention has been developed as attention to the above-described technical viewpoint has been paid, and it is an object of the present invention to provide a drive device and a drive method of a light emitting display panel in which electrical charges (electrical power) accumulated in the parasitic capacitance of a light emitting element represented by an EL element can be efficiently collected for each scan in a lighting drive device of a passive drive type display panel which realizes the above-mentioned time gradation.

A drive device of a light emitting display panel according to the present invention which has been developed in order to carry out the above-described object is a drive device of a light emitting display panel comprising a plurality of drive lines and a plurality of scan lines intersecting one another and capacitive light emitting elements which have a diode characteristic and which are connected between the respective drive lines and the respective scan lines, respectively, at respective intersecting positions between the respective drive lines and the respective scan lines, characterized in that a lighting drive period in which the light emitting elements are driven to be lit for the each scan line and a power collection period which follows the lighting drive period are set continuously, and characterized by comprising light emission control means which allows respective light emitting elements which become lighting objects to sequentially begin to be lit in response to a length of time determined in accordance with gradation control during the lighting drive period and which performs lighting control so that extinguishing timing of the respective light emitting elements which have received lighting control corresponds to the end of the lighting drive period and power collection means for collecting, during the power collection period, power which is accumulated in capacitances that the light emitting elements hold during the lighting drive period.

A drive method of a light emitting display panel according to the present invention which has been developed in order to carry out the above-described object is a drive method of a light emitting display panel comprising a plurality of drive lines and a plurality of scan lines intersecting one another and capacitive light emitting elements which have a diode characteristic and which are connected between the respective drive lines and the respective scan lines, respectively, at respective intersecting positions between the respective drive lines and the respective scan lines, characterized by performing a lighting control process in which control is performed so that respective light emitting elements which become lighting objects are allowed to sequentially begin to be lit in response to a length of time determined in accordance with gradation control for the each scan line and that extinguishing timing of the respective light emitting elements which have received lighting control corresponds and a power collection process for collecting, after the lighting control process, power which is accumulated in capacitances that the light emitting elements hold during the lighting drive process.

### BRIEF DESCRIPTION OF THE DRAWINGS

FIG. 1 is a timing diagram explaining general operations of a drive switch in the case where multi-gradation expression is realized by time gradation;

FIG. 2 is a view showing a state of the start time of a lighting drive period in accordance with the timing operation shown in FIG. 1;

FIG. 3 is a view showing a state of immediately before a power collection operation in accordance with the timing operation shown in FIG. 1;

FIG. 4 is a view showing a state of the time of the power collection operation performed after the state shown in FIG. 3;

FIG. 5 is a connection diagram showing a drive device of a display panel according to the present invention;

FIG. 6 is a timing diagram explaining operations of a drive switch performed by the present invention in the case where multi-gradation expression is realized by time gradation;

FIG. 7 is a view showing a state of the start time of a lighting drive period in accordance with the timing operation shown in FIG. 6;

FIG. 8 is a view showing a state of immediately before a power collection operation in accordance with the timing operation shown in FIG. 6;

FIG. 9 is a view showing a state of the time of the power collection operation performed after the state shown in FIG. 8;

FIG. 10 is timing diagrams explaining setting conditions of respective periods adopted in the structure shown in FIGS. 5 to 9;

FIG. 11 is a connection diagram showing a second embodiment in a drive circuit according to the present invention;

FIG. 12 is timing diagrams explaining setting conditions of respective periods adopted in the structure shown in FIG. 11; and

FIG. 13 is a connection diagram showing a third embodiment in a drive circuit according to the present invention.

### DESCRIPTION OF THE PREFERRED EMBODIMENTS

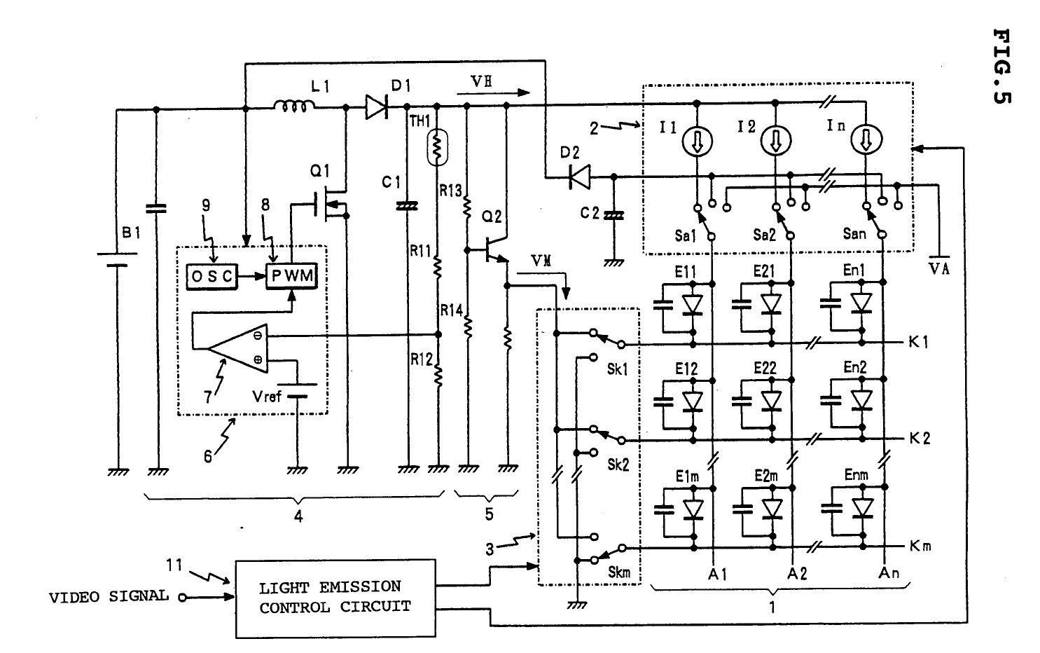

A drive device of a light emitting display panel according to the present invention will be described below with reference to an embodiment shown in FIG. 5. FIG. 5 shows an example of a light emitting display panel of a cathode line scan/anode line drive form and a drive circuit thereof. That is, in the light emitting display panel 1, anode lines A1 to An as n drive lines are arranged in a vertical (column) direction, cathode lines K1 to Km as m scan lines are arranged in a horizontal (row) direction, and organic EL elements E11 to Enm as light emitting elements denoted by symbols/marks of diodes and capacitors are arranged at portions at which the respective anode lines and cathode lines intersect one another (in total, n×m portions).

In the respective EL elements E11 to Enm constituting pixels, one ends (anode terminals in equivalent diodes of the EL elements) are connected to the anode lines, and the other ends (cathode terminals in the equivalent diodes of the EL elements) are connected to the cathode lines, corresponding to the respective intersection positions between the anode lines A1 to An provided along the vertical direction and the cathode lines K1 to Km provided along the horizontal direction. Further, the respective anode lines A1 to An are connected to an anode line drive circuit 2 provided as a data driver, and the respective cathode lines K1 to Km are connected to a cathode line scan circuit 3 provided as a scan driver, so that the respective anode and cathode lines are driven.

In the anode line drive circuit 2, constant current circuits I1 to In (hereinafter, referred to also as constant current sources) as drive sources which operate utilizing a drive voltage VH supplied from a voltage boosting circuit 4 in a later-described DC/DC converter and drive switches Sa1 to San are provided. The anode line drive circuit 2 operates in such a way that the drive switches Sa1 to San are connected to the constant current sources I1 to In sides so that current from the constant current sources I1 to In is supplied to the respective EL elements E11 to Enm arranged corresponding to the cathode lines.

In this embodiment an operation is performed in such a way that the drive switches Sa1 to San are connected to the electrical potential VA provided as a precharge power source when a precharge operation is performed before light emission control of the EL elements as described later and that the drive switches Sa1 to San are connected to one end of the capacitor C2 which functions as power collection means and whose other end is connected to a reference potential point (ground) when a power collection operation is performed.

The cathode line scan circuit 3 is provided with scan switches Sk1 to Skm corresponding to the respective cathode lines K1 to Km and operates in such a way that either a reverse bias voltage VM from a later-described reverse bias voltage generation circuit (this is also referred to as a reverse bias voltage source) 5 which is for preventing cross talk light emission or the ground potential as the reference potential point is connected to a corresponding cathode line. Thus, by connecting the constant current sources I1 to In to desired anode lines A1 to An while the cathode lines are set at the reference potential point at a predetermined cycle, the respective EL elements are allowed to emit light selectively.

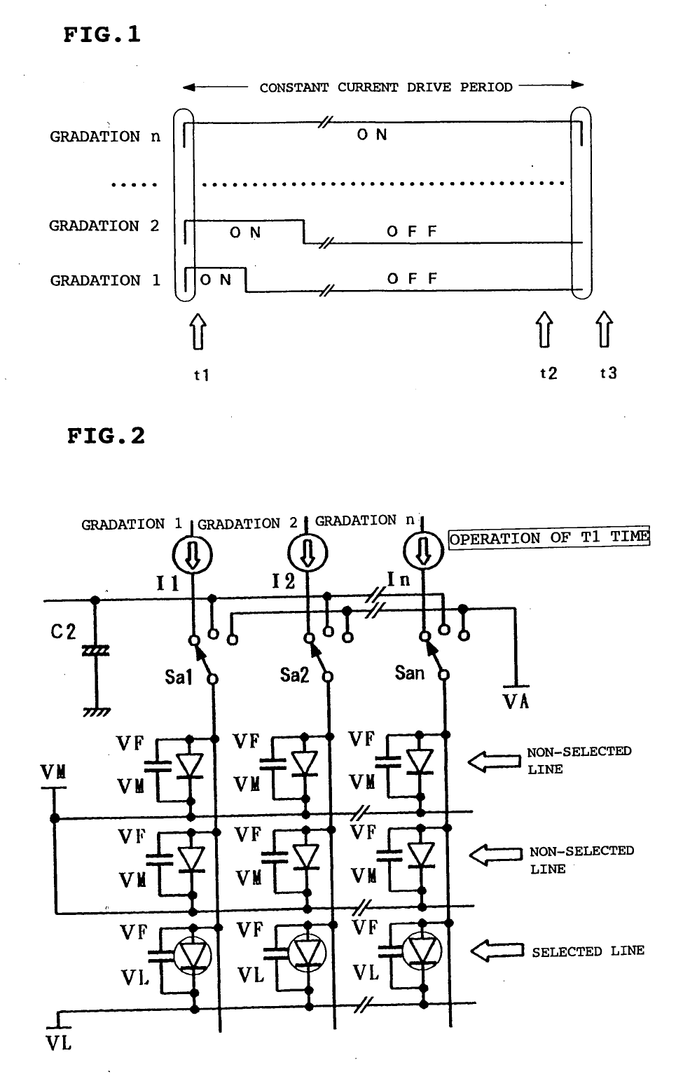

The DC/DC converter is constructed so as to generate the direct current drive voltage VH, utilizing PWM (pulse width modulation) control as the voltage boosting circuit 4 in the example shown in FIG. 1. For this DC/DC converter, well-known PFM (pulse frequency modulation) control or PSM (pulse skip modulation) control can also be utilized instead of the PWM control.

This DC/DC converter is constructed in such a way that a PWM wave outputted from a switching regulator 6 constituting a part of the voltage boosting circuit 4 controls a MOS type power FET Q1 as a switching element so that the FET Q1 is turned on at a predetermined duty cycle. That is, by an ON operation of the power FET Q1, electrical energy from a DC voltage source B1 of a primary side is accumulated in an inductor L1, and the electrical energy accumulated in the inductor L1 is accumulated in a smoothing capacitor C1 via a diode D1 accompanied by an OFF operation of the power FET Q1. By repeating of the ON/OFF operation of the power FET Q1, a DC output whose voltage is boosted can be obtained as a terminal voltage of the smoothing capacitor C1.

The DC output voltage is divided by a thermistor TH1 performing temperature compensation and resistors R11 and R12, is supplied to an error amplifier 7 in the switching regulator 6, and is compared with a reference voltage Vref in this error amplifier 7. This comparison output (error output) is supplied to a PWM circuit 8, and by controlling the duty cycle of a signal wave produced from an oscillator 9, feedback control is performed so that the output voltage is maintained at the predetermined drive voltage VH. Therefore, the output voltage by the DC/DC converter, that is, the drive voltage VH, can be expressed as follows.
VH=Vref×[(TH1+R11+R12)/R12] [mathematical formula 1]

Meanwhile, the generation circuit 5 of the reverse bias voltage VM utilized for preventing the cross talk light emission is constituted by a voltage divider circuit which divides the drive voltage VH. That is, this voltage divider circuit is composed of resistors R13, R14 and an npn transistor Q2 which functions as an emitter follower so that the reverse bias voltage VM is obtained in the emitter of the transistor Q2. Therefore, when the base-emitter voltage in the transistor Q2 is represented as Vbe, the reverse bias voltage VM obtained by this voltage divider circuit can be expressed as follows.
VM=VH×[R14/(R13+R14)]−Vbe [mathematical formula 2]

A control bus extended from a light emission control circuit 11 including a CPU is connected to the anode line drive circuit 2 and the cathode line scan circuit 3, and the scan switches Sk1 to Skm and the drive switches Sa1 to San are operated based on a video signal to be displayed. Thus, while the cathode scan lines are set at the ground potential at a predetermined cycle based on the video signal, the constant current sources I1 to In are connected to desired anode lines. Accordingly, the respective EL elements selectively emit light, and thus an image based on the video signal is displayed on the display panel 1.

The state shown in FIG. 1 shows that the mth cathode line Km is set at the ground potential to be in a scan state and that at this time the reverse bias voltage VM from the reverse bias voltage generation circuit 5 is applied to the cathode lines K1, K2, . . . in a non-scan state. Thus, this works so that respective EL elements connected to the intersection points between the driven anode lines and the cathode lines which have not been selected for scan are prevented from emitting cross talk light.

The light emission control circuit 11 operates so as to control the drive switches Sa1 to San based on later-described gradation control to control lighting time of respective EL elements which are being scanned. Further, the light emission control circuit 11 operates so as to control the drive switches Sa1 to San during a later-described power collection period and to transfer electrical charges accumulated in the parasitic capacitances of the EL elements to the power collection capacitor C2 so that the power collection operation is performed.

The anode terminal of a diode D2 is connected to the power collection capacitor C2, and the cathode terminal of this diode D2 is connected to the DC voltage source B1 of the primary side supplied to the voltage boosting circuit 4. This circuit structure operates in such a way that the electrical power collected in the capacitor C2 is supplied again to the DC voltage source B1 of the primary side.

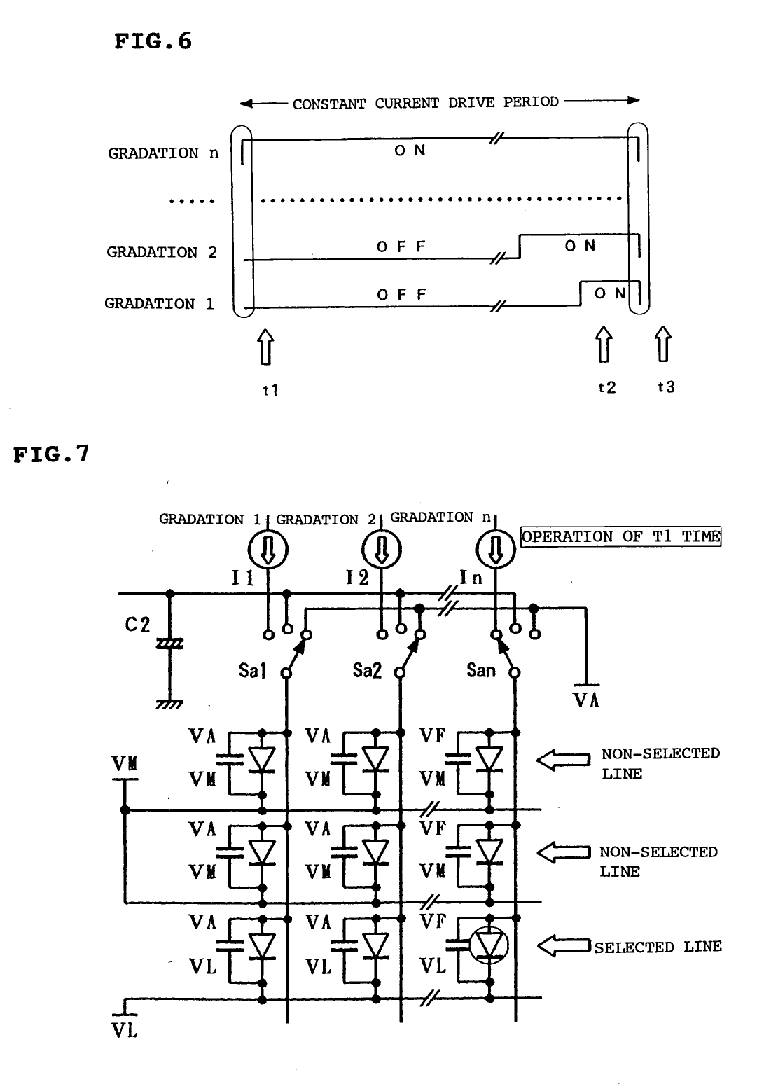

FIGS. 6 to 9 explain the operation of a light emission drive device according to the present invention which is constructed to realize multi-gradation expression by time gradation and further to efficiently collect the electrical power accumulated in the parasitic capacitances of organic EL elements which are driven to be lit accompanied by the lighting operation of the EL elements in the structure shown in FIG. 5. In the respective drawings described below, parts corresponding to the respective parts shown in FIG. 5 are designated by the same reference characters and numerals, and therefore detailed explanation thereof will be omitted properly.

First, FIG. 6 shows a control aspect of the drive switches which is performed during a lighting drive period of each scan, that is, a constant current drive period, in order to realize the above-described time gradation. The control aspect of the drive switches shown in FIG. 6 is to realize gradation expression of n steps similarly to the example shown in FIG. 1. In order to realize “gradation 1” that is the lowest gradation, a drive switch is turned on for a short period of time corresponding to gradation 1 at a point of time approximating the end of the constant current drive period, and the drive switch is turned off at the end of the constant current drive period. In FIG. 6, the ON of the drive switch means a state in which the drive switch is connected to the constant current source side, and the OFF of the drive switch means a state in which the drive switch is unconnected to the constant current source side.

In order to express “gradation 2” that is the next lower gradation, the drive switch is turned on at a timing a little before the drive switch's ON timing corresponding to the above-mentioned gradation 1, corresponding to a length of time defined in accordance with gradation 2, and the drive switch is similarly turned off at the end of the constant current drive period. Similarly, corresponding to a length of time defined in accordance with a gradation, an ON timing of the drive switch is determined, and control is performed such that the drive switch is turned off at the end of the constant current drive period similarly to the above description.

Accordingly, in order to realize “gradation n” that is the highest gradation, the drive switch is turned on at the starting timing of the constant current drive period as shown in FIG. 6, and the drive switch is turned off at the end of the constant current drive period similarly. That is, in order to realize the highest gradation n, the drive switch is turned on during the entire period of the constant current drive period.

As can be understood also from the control aspect shown in FIG. 6, in the control aspect of the drive switch performed by the drive method according to the present invention, control is performed such that lighting of the respective EL elements that become lighting objects during the constant current drive period as the lighting drive period is begun sequentially in response to the length of the predetermined time in accordance with gradation control and that extinguishing timing of the respective light emitting elements which receives lighting control corresponds to the end of the lighting drive period. Thus, the lighting time of the EL element during the constant current drive period is controlled in accordance with gradation, and multi-gradation expression can be realized for each pixel.

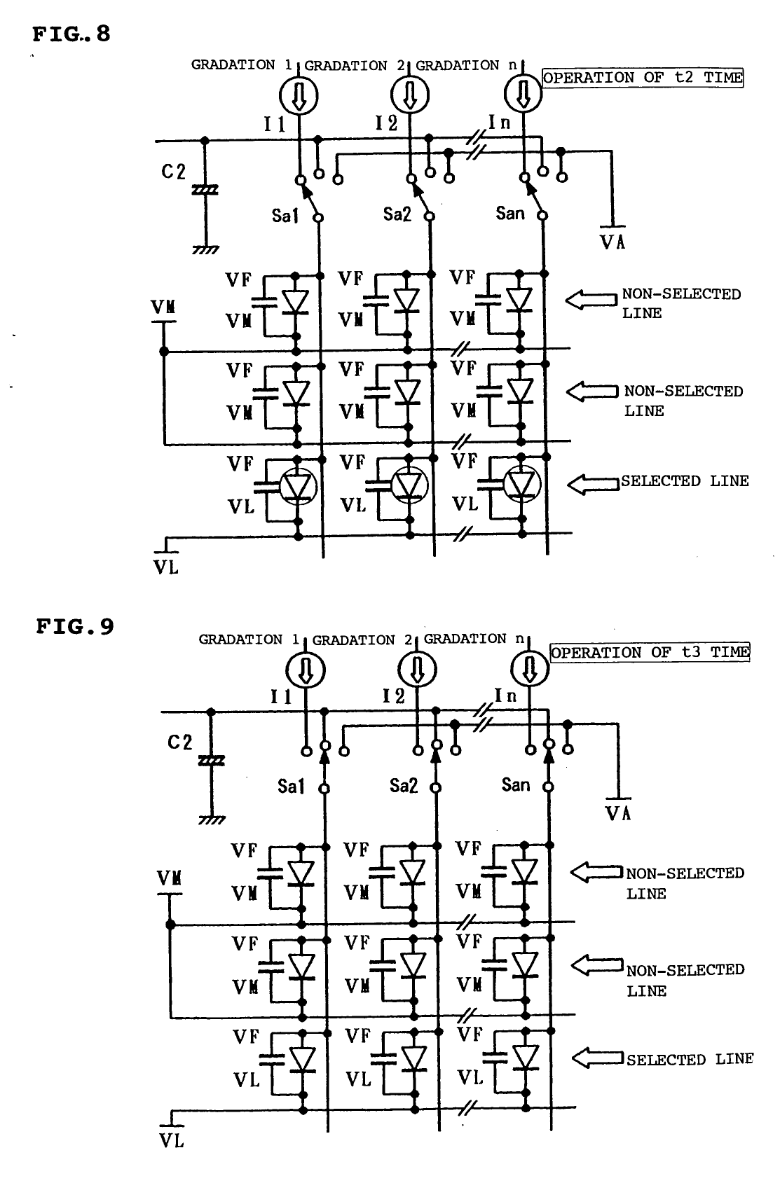

FIGS. 7 to 9 shown next sequentially explain the aspect of control in timings shown by t1 to t3 in FIG. 6, wherein FIG. 7 (that is, the view showing an operation of t1 time of FIG. 6) shows a state of the start time of the constant current drive period as the lighting drive period, FIG. 8 (that is, the view showing an operation of t2 time of FIG. 6) shows a state of immediately before the power collection operation, and FIG. 9 (that is, the view showing an operation of t3 time of FIG. 6) shows a state of a power collection operation time, respectively.

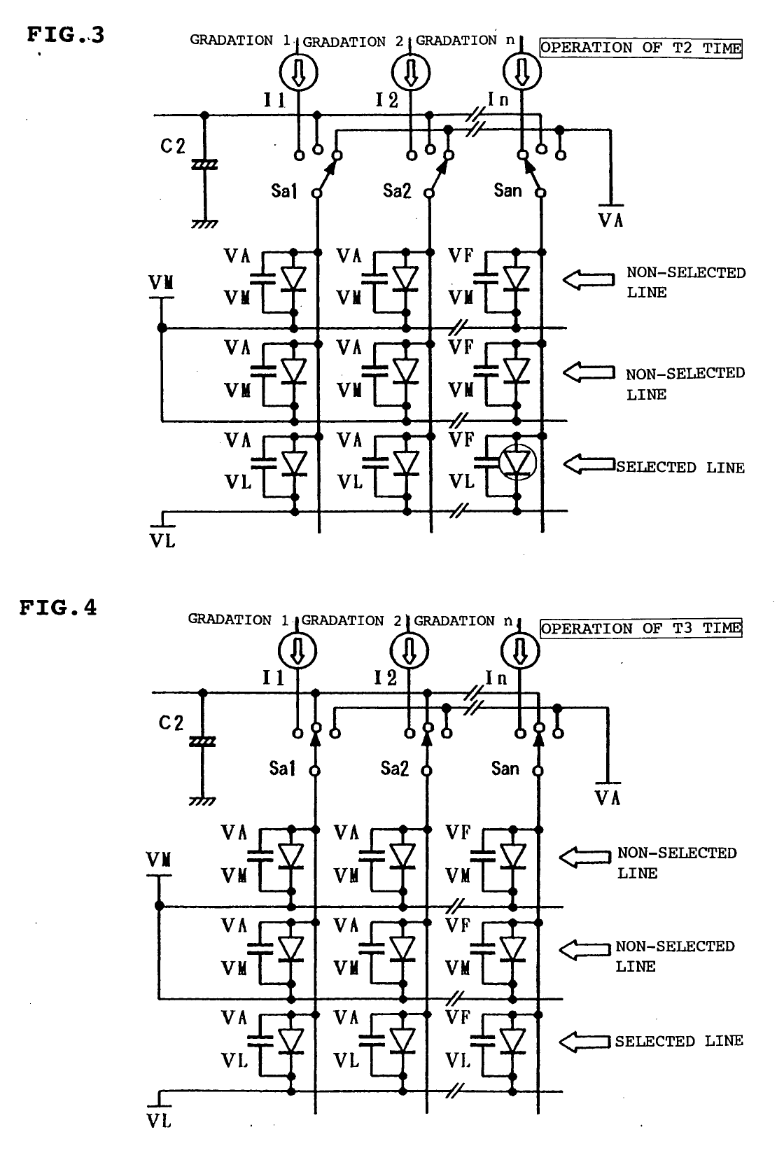

FIGS. 7 to 9 are shown by forms similar to those of FIGS. 2 to 4 already described. That is, in any of FIGS. 7 to 9, for convenience of space, three drive lines and scan lines are drawn in the column direction and the row direction, respectively. FIGS. 7 to 9 show a case where pixels corresponding to an anode line of the left side are expressed at “gradation 1”, pixels corresponding to the central anode line are expressed at “gradation 2”, and pixels corresponding to an anode line of the right side is expressed at “gradation n”, respectively, among the anode lines as the three drive lines arranged in the column direction. Shown is a state in which the upper two cathode lines are brought to a non-scan state (non-selected lines) and the bottom one cathode line (the third cathode line) is brought to a scan state (selected line) among the cathode lines as the three scan lines arranged in the row direction.

Here, at the time of t1 shown in FIG. 6, that is, at the start time of the constant current drive period, only the drive switch by which “gradation n” that is the highest gradation is expressed is controlled to be in an ON state. That is, as shown in FIG. 7, only the drive switch San by which the highest gradation n is expressed is connected to the constant current source In, and the drive switches Sa1, Sa2 by which gradation land gradation 2 are expressed are connected to the electrical potential VA as the precharge power source.

At this time the upper two cathode lines are made to the non-selected lines as described above, and the reverse bias voltage VM is supplied thereto. The voltage VL is supplied to the third cathode line. Accordingly, at this time only an EL element controlled to be gradation n among the selected lines is driven to be lit as circled. At this time the forward voltage of the EL element driven to be lit is designated by VF, and a potential relationship of this time is made to VM>VF>VA>VL.

Although only the drive switch San corresponding to the anode line expressed at gradation n is connected to the constant current source In in the state shown in FIG. 7, the drive switches operate so as to be sequentially connected to the constant current source side in accordance with gradation expression as described above so as to drive and light corresponding EL elements.

Next, in the state of immediately before the power collection operation shown in FIG. 8, drive current is supplied from the constant current sources to all the anode lines which become lighting drive objects on the selected lines. This is because the drive switch is sequentially connected to the constant current source side in accordance with gradation expression so that the EL elements on the corresponding selected line are driven to be lit as described above. Accordingly, at this time EL elements which become lighting objects on the selected line are driven to be lit as circled.

Then, in the power collection operation time shown in FIG. 9, the drive switches Sa1 to San are all connected to the power collection capacitor C2 side. Thus, the anode terminals of the EL elements are all connected to the power collection capacitor C2 via the respective anode lines. As a result, electrical charges accumulated in the parasitic capacitances of the respective EL elements are transferred to the power collection capacitor C2. At this time electrical charges which are collectable in the capacitor C2 and which are accumulated in parasitic capacitances connected in parallel to the diode elements whose anode terminals are VF become objects.

Accordingly, with this embodiment, electrical charges accumulated in all the EL elements arranged in the light emitting display panel can be collected by the capacitor C2. Therefore, it is desired that the capacitance value of the power collection capacitor C2 has a value greater than a synthesized capacitance value of all light emitting elements arranged in the light emitting display panel (obtained by multiplying capacitance value per one EL element, the number of drive lines, and the number of scan lines, together).

Electrical charges collected in the power collection capacitor C2 based on the above-described operation are supplied to the DC voltage source of the primary side of the DC/DC converter via the diode D2 as described based on FIG. 5. Accordingly, since electrical power by electrical charges accumulated in the parasitic capacitances of the respective EL elements nulled for each scan is efficiently colleted in the capacitor C2 for each scan to be supplied again, as a result, a low power consumption of the lighting drive device can be realized.

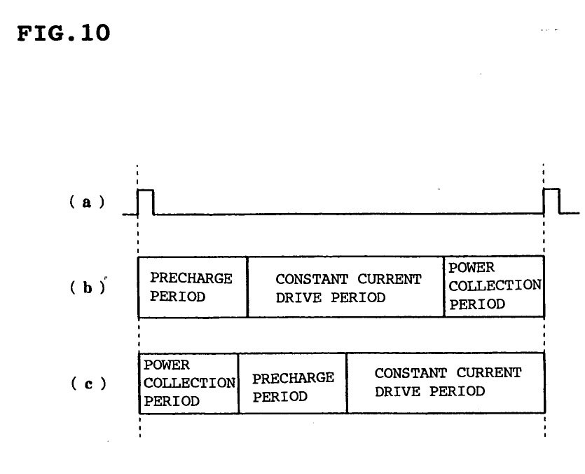

FIG. 10 explains control sequences of a case where a precharge period in which a forward bias is applied to the parasitic capacitances of the EL elements which are to be driven to be lit next is set, in addition to the above-described constant current drive period and power collection period. In a precharge operation performed during this precharge period, the drive switches Sa1 to San are all connected to the electrical potential VA provided as the precharge power source for example in FIG. 7.

Thus, the forward bias having the value of VA-VL is applied to the respective EL elements connected to the selected lines that become lighting objects next, whereby the parasitic capacitances of said elements are charged. It is needless to say that the forward bias having the value of VA-VL charged in the respective EL elements connected to the selected lines is a voltage having a value obtained before respective elements are driven to be lit (a voltage lower than the above-mentioned Vth).

The precharge period is set immediately before the constant current drive period already described. Accordingly, in one preferred control sequence, a precharge period is set as shown in FIG. 10B in synchronization with a scan (horizontal) synchronization signal shown as FIG. 10A. Then, the constant current drive period and the following power collection period are set after this precharge period.

In another preferred control sequence, a power collection period is set as shown in FIG. 10C in synchronization with the scan (horizontal) synchronization signal shown as FIG. 10A. Then, the precharge period and the following constant current drive period are set after this power collection period. In any case, scans for the scan lines are performed continuously, and the same interactions can be obtained substantially even if synchronization for the scan synchronization signal is of either FIG. 10B or FIG. 10C.

Timing control of the respective periods shown in FIG. 10 and switching control of the respective drive switches Sa1 to San based on gradation control in the constant current drive period are performed for example by the control circuit 11 constituting light emission control means shown in FIG. 5. In this case, though not specifically shown, a counter is provided in the light emission control circuit 11, and by count numbers of this counter, the switching control of the respective drive switches Sa1 to San based on gradation control and switching timing of the respective periods shown in FIG. 10 are controlled.

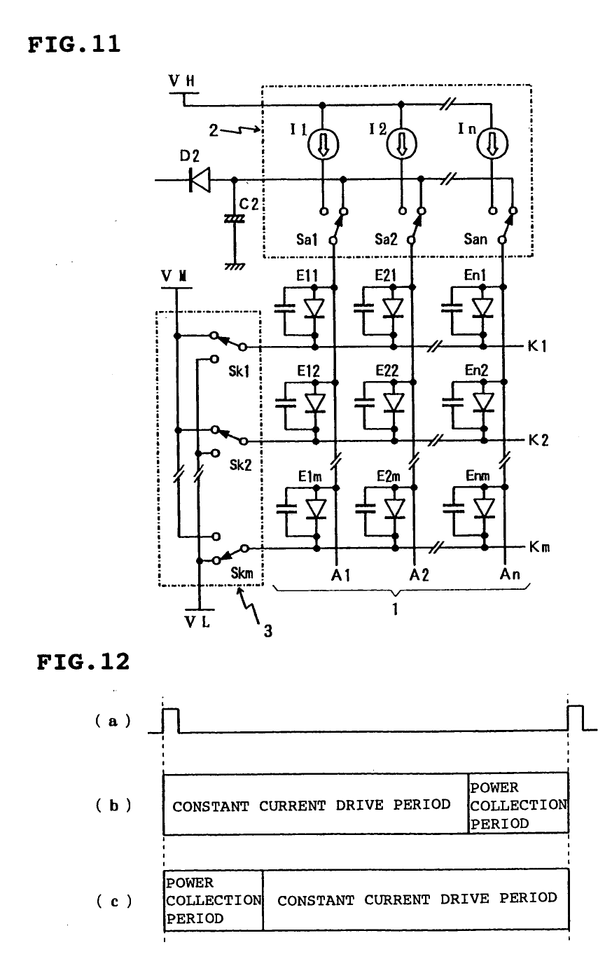

Although above explanation with reference to FIGS. 5 to 10 correspond to a drive device of a display panel in which a precharge operation can be performed, the present invention can be applied to a drive device which does not involve any precharge operation. FIG. 11 shows its example. The respective drive switches Sa1 to San in the data driver 2 are constructed so as to be selectively switched to either the constant current sources 11 to In or the power collection capacitor C2.

Control sequences performed in a drive device shown in FIG. 11 is shown in FIG. 12. In one aspect of these control sequences, the constant current drive period is set as shown in FIG. 12B in synchronization with the scan (horizontal) synchronization signal shown as FIG. 12A. The power collection period is set after the constant current drive period. In another aspect of the control sequences, the power collection period is set as shown in FIG. 12C in synchronization with the scan (horizontal) synchronization signal shown as FIG. 12A. Then, the constant current drive period is set after the power collection period. As already described, the scans for the scan lines are performed continuously, and the same interactions can be obtained substantially even if synchronization for the scan synchronization signal is of either FIG. 12B or FIG. 12C.

In the embodiment shown in FIG. 11 also, the respective drive switches Sa1 to San are switched from the capacitor C2 side to the constant current sources I1 to In side sequentially in response to the length of the time predetermined in accordance with gradation control during the constant current drive period. The constant current drive period as the lighting drive period is shifted to the power collection period at the end thereof, and an operation in which the drive switches Sa1 to San are all switched to the capacitor C2 side is performed.

The above-described embodiment shown in FIG. 11 is similar to the embodiment described with reference to FIGS. 5 to 10 regarding the matter that the electrical power accumulated in the parasitic capacitances of the light emitting elements can be efficiently collected during the power collection period although the precharge operation is not performed. Accordingly, in the embodiment shown in FIG. 11 also, a low power consumption of the lighting drive device can be realized.

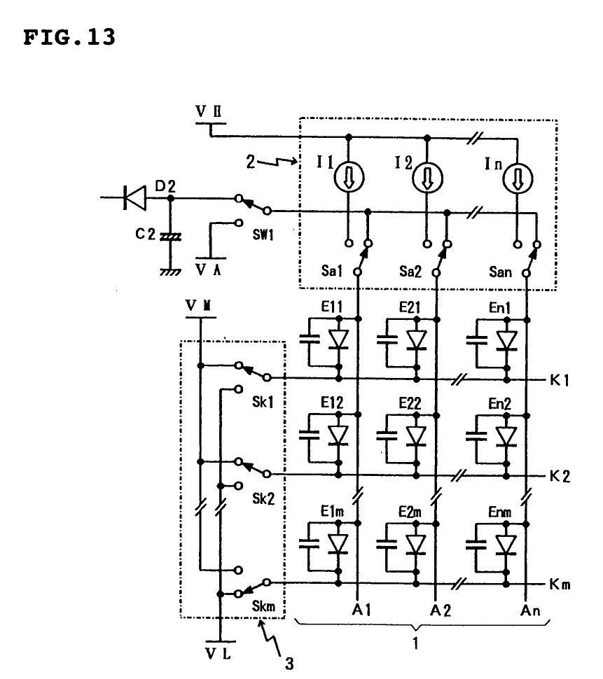

Next, FIG. 13 further shows another embodiment in a drive device of a display panel according to the present invention. In the example shown in this FIG. 13, similarly to the example shown in FIG. 11, the respective drive switches Sa1 to San in the data driver 2 are constructed so as to be selectively switched to either the constant current sources 11 to In or the power collection capacitor C2 side. Meanwhile, a change-over switch SW1 is provided in the power collection capacitor C2 side, and this side is constructed such that the data driver 2 side is connected to the capacitor C2 side or the electrical potential VA provided as the precharge power source via this switch Sw1.

With the embodiment shown in this FIG. 13, by switching the switch SW1 to the direction different from that of the drawing, the precharge operation can be performed. During the constant current drive period as the lighting drive period, the respective drive switches Sa1 to San are suitably connected to the constant current sources I1 to In side. During the power collection period after the constant current drive period, the switches SW1, Sa1 to San are brought to the state shown in FIG. 13. In the embodiment shown in this FIG. 13 also, similarly to the embodiments already described, the electrical power accumulated in the parasitic capacitances of the light emitting elements can be efficiently collected, and a low power consumption of the lighting drive device can be realized.

1. A drive device of a light emitting display panel comprising a plurality of drive lines and a plurality of scan lines intersecting one another and capacitive light emitting elements which have a diode characteristic and which are connected between the respective drive lines and the respective scan lines, respectively, at respective intersecting positions between the respective drive lines and the respective scan lines,
the drive device of the light emitting display panel characterized in that
a lighting drive period in which the light emitting elements are driven to be lit for the each scan line and a power collection period which follows the lighting drive period are set continuously,
and characterized by comprising
light emission control means which allows respective light emitting elements which become lighting objects to sequentially begin to be lit in response to a length of time determined in accordance with gradation control during the lighting drive period and which performs lighting control so that extinguishing timing of the respective light emitting elements which have received lighting control corresponds to the end of the lighting drive period and
power collection means for collecting, during the power collection period, power which is accumulated in capacitances that the light emitting elements hold during the lighting drive period.

2. The drive device of the light emitting display panel according to claim 1, characterized by being constructed in such a manner that a precharge period in which a forward bias having a value obtained before the light emitting element is lit is applied to the capacitance that the respective light emitting element that become a scan object holds is further set immediately before the lighting drive period for the light emitting elements.

3. The drive device of the light emitting display panel according to claim 1, characterized by being constructed in such a manner that the respective drive lines are connected to respective drive sources for the light emitting elements during the lighting drive period and are connected to the power collection means during the power collection period.

4. The drive device of the light emitting display panel according to claim 2, characterized by being constructed in such a manner that the respective drive lines are connected to respective drive sources for the light emitting elements during the lighting drive period and are connected to the power collection means during the power collection period.

5. The drive device of the light emitting display panel according to claim 3, characterized in that the drive source for the light emitting elements is a constant current circuit.

6. The drive device of the light emitting display panel according to claim 4, characterized in that the drive source for the light emitting elements is a constant current circuit.

7. The drive device of the light emitting display panel according to any one of claims 1 to 6, characterized by being constructed in such a manner that a reverse bias potential for the light emitting elements is applied to the light emitting elements which are connected to the scan lines of a non-scan state via the scan lines.

8. The drive device of the light emitting display panel according to any one of claims 1 to 6, characterized by being constructed in such a manner that the power collection means includes a power collection capacitor which collects power accumulated, during the lighting drive period of the light emitting elements, in the capacitances that the light emitting elements hold via the drive lines so that the power accumulated in the power collection capacitor is supplied to a DC voltage source of a primary side of a DC/DC converter which drives the light emitting display panel.

9. The drive device of the light emitting display panel according to claim 7, characterized by being constructed in such a manner that the power collection means includes a power collection capacitor which collects power accumulated in the capacitance that the light emitting element holds during the lighting drive period of the light emitting elements via the drive lines so that the power accumulated in the power collection capacitor is supplied to a DC voltage source of a primary side of a DC/DC converter which drives the light emitting display panel.

10. The drive device of the light emitting display panel according to claim 8, characterized in that the capacitance value of the power collection capacitor is set at a value greater than a synthesized capacitance value of all light emitting elements arranged in the light emitting display panel.

11. The drive device of the light emitting display panel according to claim 9, characterized in that the capacitance value of the power collection capacitor is set at a value greater than a synthesized capacitance value of all light emitting elements arranged in the light emitting display panel.

12. The drive device of the light emitting display panel according to any one of claims 1 to 6, characterized in that the light emitting elements constituting the light emitting display panel are organic EL elements.

13. The drive device of the light emitting display panel according to claim 7, characterized in that the light emitting elements constituting the light emitting display panel are organic EL elements.

14. The drive device of the light emitting display panel according to claim 8, characterized in that the light emitting elements constituting the light emitting display panel are organic EL elements.

15. The drive device of the light emitting display panel according to claim 9, characterized in that the light emitting elements constituting the light emitting display panel are organic EL elements.

16. The drive device of the light emitting display panel according to claim 10, characterized in that the light emitting elements constituting the light emitting display panel are organic EL elements.

17. The drive device of the light emitting display panel according to claim 11, characterized in that the light emitting elements constituting the light emitting display panel are organic EL elements.

18. A drive method of a light emitting display panel comprising a plurality of drive lines and a plurality of scan lines intersecting one another and capacitive light emitting elements which have a diode characteristic and which are connected between the respective drive lines and the respective scan lines, respectively, at respective intersecting positions between the respective drive lines and the respective scan lines,
the drive method of the light emitting display panel characterized by performing
a lighting control process in which control is performed so that respective light emitting elements which become lighting objects are allowed to sequentially begin to be lit in response to a length of time determined in accordance with gradation control for the each scan line and that extinguishing timing of the respective light emitting elements which have received lighting control corresponds and
a power collection process for collecting, after the lighting control process, power which is accumulated in capacitances that the light emitting elements hold during the lighting drive process.

19. The drive method of the light emitting display panel according to claim 18, characterized by performing a precharge process in which a forward bias having a value obtained before the element is lit is applied to the capacitance that the respective light emitting element that become a lighting object holds immediately before the lighting control period in which the light emitting elements are driven to be lit.
